(19) United States
(12) Patent Application Publication
(10) Pub. No.: US 2013/0050342 A1
(43) Pub. Date: Feb. 28, 2013

(54) DROP EJECTOR SHAPE FOR IMPROVED REFILL

(71) Applicant: Brian Gray Price, Pittsford, NY (US)

(72) Inventor: Brian Gray Price, Pittsford, NY (US)

(21) Appl. No.: 13/221,966

(22) Filed: Aug. 31, 2011

(51) Int. Cl. B41J 2/14

(52) U.S. Cl. 347/47

(57) ABSTRACT

An inkjet printhead including a drop ejector, the drop ejector includes a substrate having a surface disposed along an xy plane; a nozzle plate including a nozzle; a resistive heater disposed on the surface of the substrate proximate the nozzle, the resistive heater including a width along an x direction; and a chamber at least partially enclosing the resistive heater, the chamber including: a y axis; a pair of nonparallel opposing walls defining a variable width of the chamber along the x direction; and a chamber inlet having an inlet width along the x direction, the inlet width being less than the width of the resistive heater, wherein the variable width of the chamber gradually increases between the inlet of the chamber and an edge of the heater that is nearest to the inlet of the chamber.

### FIELD OF THE INVENTION

The present invention relates generally to a drop ejector, such as an inkjet drop ejector, and more particularly to a design of the drop ejector channel and chamber that facilitates refill of the chamber.

### BACKGROUND OF THE INVENTION

In drop-on-demand inkjet printing ink drops are ejected onto a recording surface using a pressurization actuator (thermal or piezoelectric, for example). Selective activation of the actuator causes the formation and ejection of a flying ink drop that crosses the space between the printhead and the print media and strikes the print media. The formation of printed images is achieved by controlling the individual formation of ink drops, as is required to create the desired image.

Motion of the print medium relative to the printhead can consist of keeping the printhead stationary and advancing the print medium past the printhead while the drops are ejected. This architecture is appropriate if the nozzle array on the printhead can address the entire region of interest across the width of the print medium. Such printheads are sometimes called pagewidth printheads. A second type of printer architecture is the carriage printer, where the printhead nozzle array is somewhat smaller than the extent of the region of interest for printing on the print medium and the printhead is mounted on a carriage. In a carriage printer, the print medium is advanced a given distance along a print medium advance direction and then stopped. While the print medium is stopped, the printhead carriage is moved in a carriage scan direction that is substantially perpendicular to the print medium advance direction as the drops are ejected from the nozzles. After the carriage has printed a swath of the image while traversing the print medium, the print medium is advanced, the carriage direction of motion is reversed, and the image is formed swath by swath.

A drop ejector in a drop on demand inkjet printhead includes a chamber having an ink inlet for providing ink to the chamber, and a nozzle for jetting drops out of the chamber. The chamber is used to develop a pressure on the ink in order to eject drops through the nozzle. Two side-by-side drop ejectors are shown in prior art FIG. 1 as an example of a conventional thermal inkjet drop on demand drop ejector configuration. Partition walls 20 are formed on a base plate 10 and define chambers 22. A nozzle plate 30 is formed on the partition walls 20 and includes nozzles 32, each nozzle 32 being disposed over a corresponding chamber 22. The height H of the chamber 22 between the base plate 10 and the nozzle plate 30 is the thickness of the partition walls 20. The partition walls 20 will sometimes alternatively be called side walls herein. Ink enters chambers 22 by first going through an opening in base plate 10, or around an edge of base plate 10, and then through ink paths 24, as indicated by the arrows in FIG. 1.

FIG. 2 is a schematic top view of the configuration of the prior art drop ejector type shown in FIG. 1. Chamber 22 includes an inlet 27 having a first edge 27a and a second edge 27b. Inlet 27 includes a width W between first edge 27a and second edge 27b. Chamber 22 includes a center 21 (indicated by the cross hairs). In this example, the nozzle 32 and a heater 13 have centers that are in line with the chamber center 21, but that is not always the case. First edge 27a and second edge 27b of inlet 27 are substantially symmetrically arranged relative to chamber center 21, i.e. they are disposed on opposite sides of the chamber center 21, relative to the inlet width direction. Ink path 24 (called a channel herein) includes an entry region 25, a neck region 26, and then a gradually wider region that connects to inlet 27 of chamber 22. Ink enters the chamber 22 from an ink feed 35, an opening in the base plate 10 (called a substrate herein) through channel 24. When heater 13 is briefly pulsed, it vaporizes a portion of the ink, and the growing vapor bubble pushes a drop of ink out of nozzle 32. Some of the force of the growing bubble pushes ink backward through channel 24, but chamber walls 29 and the increased fluid impedance due to neck region 26 are designed to direct a large portion of the force of the growing vapor bubble to eject the drop of ink. The vapor bubble is either vented through the nozzle 32, or it collapses in chamber 22. Capillary action and ink momentum due to reduced pressure in the chamber 22 draw ink in to refill chamber 22. The fluid impedance of channel 24 is designed to permit rapid refill for ejection of the next drop, as well as to direct vapor bubble forces toward drop ejection.

A drawback of prior art chamber configurations, including the configurations of FIGS. 1 and 2, is that some regions of the chamber 22, such as corners 28, can have relatively low fluid velocity during both drop ejection and ink refill. Air bubbles and particulates can accumulate in such low flow regions. Air can enter the chamber 22 through nozzle 32 or air can come out of solution from being dissolved in the ink. Unlike ink vapor bubbles which can condense completely, air bubbles are persistent unless they are removed from the chamber. Although very small air bubbles may not be a problem, as the air bubbles accumulate and grow, they can interfere with proper jetting.

A second drawback of the chamber configurations of FIGS. 1 and 2 is that for sufficiently large chamber height H, as would be appropriate for a moderately large drop size, and for large contact angle between the ink and the chamber walls, capillary pressure alone may not be sufficient to reprime the chamber in the event that the chamber is completely deprimed. In other words, if the liquid ink is removed from the chamber and if there no momentum of the ink to help push it back into the chamber, the ink can become pinned in the channel or at the inlet of the chamber. No drops can be ejected from that chamber until ink is again drawn into the chamber. External assistance for priming can be done by vacuum priming and sucking ink through the nozzles while the printhead face is enclosed within the cap of a maintenance station, but that can be wasteful of ink.

What is needed is a drop ejector configuration that facilitates refill of the chamber via capillary pressure. Facilitating refill can be beneficial not only for avoiding jet misfires, but also for enabling higher jet firing frequencies, thereby improving printing throughput. Facilitating refill by increasing the capillary pressure at the drop ejector can also provide improved latitude of operation relative to changes in back pressure from the ink supply.

### SUMMARY OF THE INVENTION

The present invention is directed to overcoming one or more of the problems set forth above. Briefly summarized, according to one aspect of the invention, the invention resides in an inkjet printhead including a drop ejector, the drop ejector comprising a substrate having a surface disposed along an xy plane; a nozzle plate including a nozzle; a resistive heater disposed on the surface of the substrate proximate the nozzle, the resistive heater including a width along an x direction; and a chamber at least partially enclosing the resistive heater, the chamber including: a y axis; a pair of nonparallel opposing walls defining a variable width of the chamber along the x direction; and a chamber inlet having an inlet width along the x direction, the inlet width being less than the width of the resistive heater, wherein the variable width of the chamber gradually increases between the inlet of the chamber and an edge of the heater that is nearest to the inlet of the chamber.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a perspective cutaway of a prior art drop generator configuration for a thermal inkjet drop-on-demand printhead;

FIG. 2 is a schematic top view of the drop generator configuration of FIG. 1;

FIG. 3 is a schematic representation of an inkjet printer system;

FIG. 4 is a perspective of a portion of a printhead;

FIG. 5 is a perspective of a portion of a carriage printer;

FIG. 6 is a schematic side view of an exemplary paper path in a carriage printer;

FIG. 7 shows a cross-sectional view of a portion of a chamber of a drop ejector, where the section is perpendicular to the plane of the substrate;

FIG. 8 shows a cross-sectional view of a portion of the chamber of FIG. 7, where the section is parallel to the xy plane of the substrate;

FIG. 9 shows a perspective of the walls of a single-inlet chamber of a drop ejector according to an embodiment of the invention;

FIG. 10 is a top view of a drop ejector including the single-inlet chamber shown in FIG. 9;

FIG. 11 is a cross-sectional view of the drop ejector of FIG. 10 along the y axis;

FIG. 12 shows a perspective of a dual-inlet chamber of a drop ejector according to another embodiment of the invention;

FIG. 13 is a top view of a dual-feed drop ejector including the dual-inlet chamber shown in FIG. 12; and

FIG. 14 shows a top view of a portion of an inkjet printhead die 110 having an array of four dual-feed drop ejectors of the type shown in FIGS. 12 and 13.

### DETAILED DESCRIPTION OF THE INVENTION

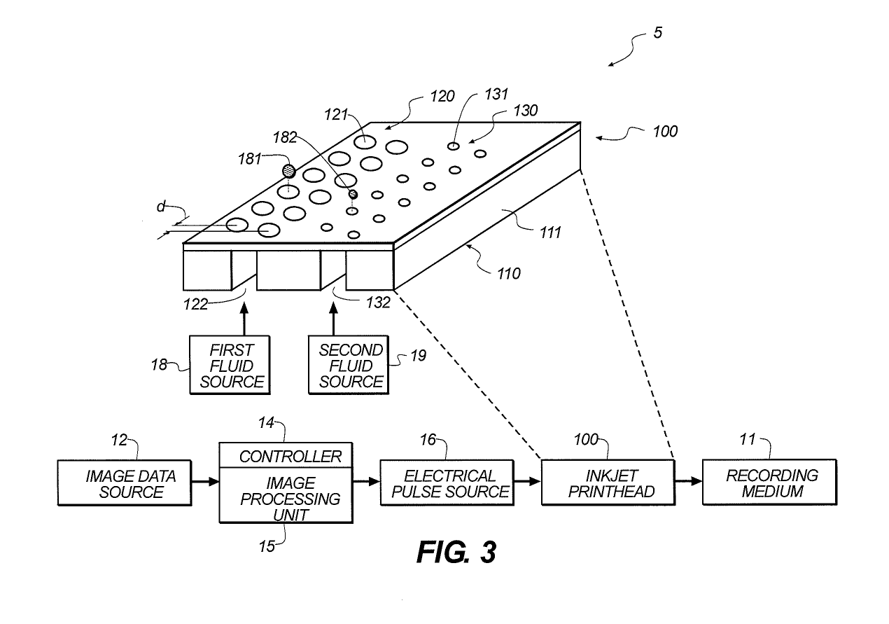

Referring to FIG. 3, a schematic representation of an inkjet printer system 10 is shown, for its usefulness with the present invention and is fully described in U.S. Pat. No. 7,350,902, and is incorporated by reference herein in its entirety. An inkjet printer system 5 includes an image data source 12, which provides data signals that are interpreted by a controller 14 as being commands to eject drops. Controller 14 includes an image processing unit 15 for rendering images for printing, and outputs signals to an electrical pulse source 16 of electrical energy pulses that are inputted to an inkjet printhead 100, which includes at least one inkjet printhead die 110.

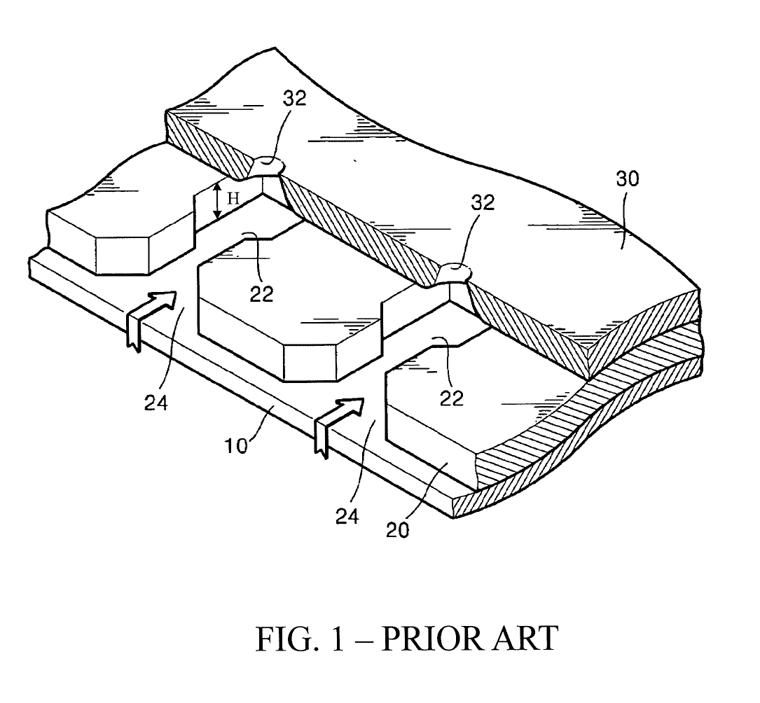

In the example shown in FIG. 3, there are two nozzle arrays. Nozzles 121 in a first nozzle array 120 have a larger opening area than nozzles 131 in a second nozzle array 130. In this example, each of the two nozzle arrays 120, 130 has two staggered rows of nozzles, each row having a nozzle density of 600 per inch. The effective nozzle density then in each array is 1200 per inch (i.e. d= 1/1200 inch in FIG. 1). If pixels on a recording medium 11 were sequentially numbered along the paper advance direction, the nozzles from one row of an array would print the odd numbered pixels, while the nozzles from the other row of the array would print the even numbered pixels.

In fluid communication with each nozzle array 120, 130 is a corresponding ink delivery pathway 122. The ink delivery pathway 122 is in fluid communication with the first nozzle array 120, and ink delivery pathway 132 is in fluid communication with the second nozzle array 130. Portions of ink delivery pathways 122 and 132 are shown in FIG. 3 as openings through printhead die substrate 111. One or more inkjet printhead die 110 will be included in inkjet printhead 100, but for greater clarity only one inkjet printhead die 110 is shown in FIG. 3. In FIG. 3, a first fluid source 18 supplies ink to first nozzle array 120 via ink delivery pathway 122, and a second fluid source 19 supplies ink to second nozzle array 130 via ink delivery pathway 132. Although distinct fluid sources 18 and 19 are shown, in some applications it can be beneficial to have a single fluid source supplying ink to both the first nozzle array 120 and the second nozzle array 130 via ink delivery pathways 122 and 132 respectively. Also, in some embodiments, fewer than two or more than two nozzle arrays 120, 130 can be included on printhead die 110. In some embodiments, all nozzles on inkjet printhead die 110 can be the same size, rather than having multiple sized nozzles on inkjet printhead die 110.

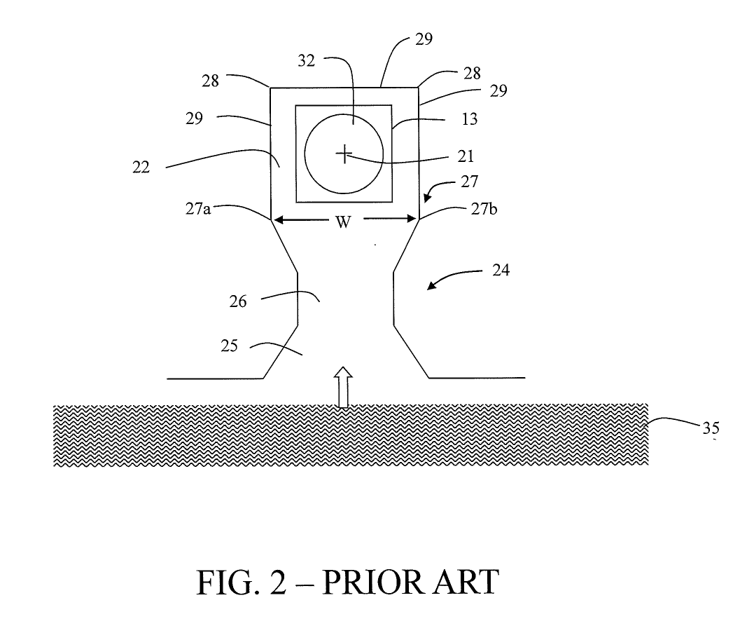

In a drop-on-demand printhead, a drop ejector includes a drop forming element as well as the nozzle. Not shown in FIG. 3, are the drop forming elements associated with the nozzles. Drop forming elements can be of a variety of types, some of which include a heating element to vaporize a portion of ink within a chamber and thereby cause ejection of a droplet (as described in the background relative to FIG. 2), or a piezoelectric transducer to constrict the volume of a chamber and thereby cause ejection, or an actuator which is made to move within a chamber (for example, by heating a bi-layer element) and thereby cause ejection. In any case, electrical pulses from electrical pulse source 16 are sent to the various drop ejectors according to the desired deposition pattern. In the example of FIG. 3, droplets 181 ejected from the first nozzle array 120 are larger than droplets 182 ejected from the second nozzle array 130, due to the larger nozzle opening area. Typically other aspects of the drop ejector, such as heater size, associated respectively with nozzle arrays 120 and 130 are also sized differently in order to optimize the drop ejection process for the different sized drops. An advantage of printhead die where all drop ejectors are intended to eject drops of the same nominal size is that chamber height H (see FIG. 1) can readily be optimized for ejecting the nominal drop size without making trade-offs between different nominal sized drops. Typically a larger nominal drop size is associated with a greater chamber height than a smaller nominal drop size would be.

During operation of an inkjet printer, droplets of ink are deposited on a recording medium 11 to form the desired image. While the examples described herein will be in the context of inkjet printing, there are other types of drop ejectors other than for inkjet printing that the drop ejector shape invention described herein can be useful for to promote refill of the chamber.

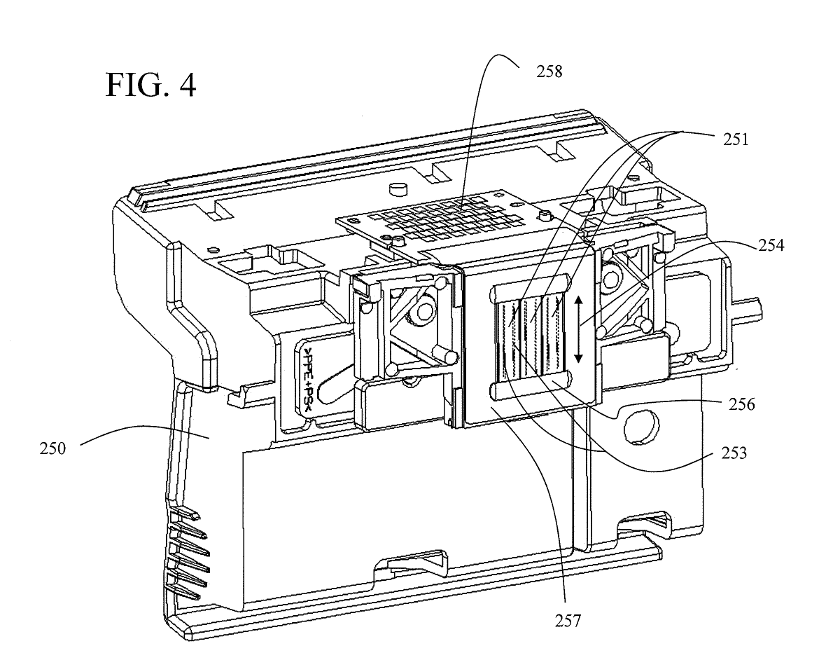

FIG. 4 shows a perspective of a portion of a printhead 250, which is an example of the inkjet printhead 100. Printhead 250 includes three printhead die 251 (similar to printhead die 110 in FIG. 3), each printhead die 251 containing two nozzle arrays 253, so that printhead 250 contains six nozzle arrays 253 altogether. The six nozzle arrays 253 in this example can each be connected to separate ink sources (not shown in FIG. 4); such as cyan, magenta, yellow, text black, photo black, and a colorless protective printing fluid. Each of the six nozzle arrays 253 is disposed along nozzle array direction 254, and the length of each nozzle array 253 along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving printhead 250 across the recording medium 11. Following the printing of a swath, the recording medium 11 is advanced along a media advance direction that is substantially parallel to nozzle array direction 254.

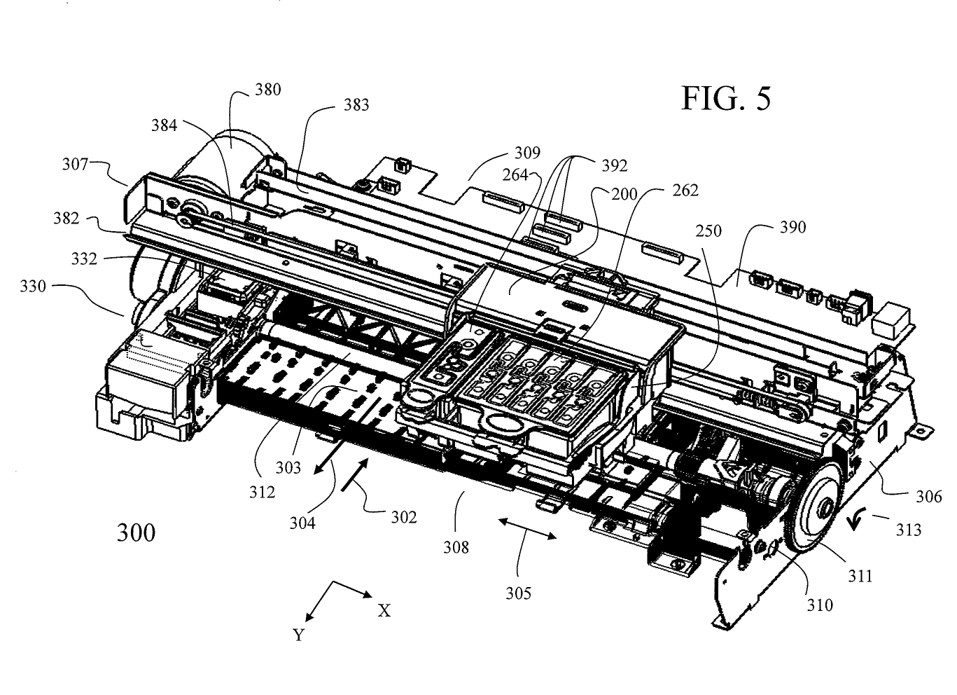

Also shown in FIG. 4 is a flex circuit 257 to which the printhead die 251 are electrically interconnected, for example, by wire bonding or TAB bonding. The interconnections are covered by an encapsulant 256 to protect them. Flex circuit 257 bends around the side of printhead 250 and connects to a connector board 258. When printhead 250 is mounted into a carriage 200 (see FIG. 5), a connector board 258 is electrically connected to a connector (not shown) on the carriage 200, so that electrical signals can be transmitted to the printhead die 251.

FIG. 5 shows a portion of a desktop carriage printer. Some of the parts of the printer have been hidden in the view shown in FIG. 5 so that other parts can be more clearly seen. A printer chassis 300 has a print region 303 across which carriage 200 is moved back and forth in carriage scan direction 305 along the X axis, between a right side 306 and a left side 307 of printer chassis 300, while drops are ejected from printhead die 251 (not shown in FIG. 5) on printhead 250 that is mounted on carriage 200. A carriage motor 380 moves a belt 384 to move carriage 200 along a carriage guide rail 382. An encoder sensor (not shown) is mounted on carriage 200 and indicates carriage location relative to an encoder fence 383.

Printhead 250 is mounted in carriage 200, and multi-chamber ink supply 262 and a single-chamber ink supply 264 are mounted in the printhead 250. The mounting orientation of printhead 250 is rotated relative to the view in FIG. 4, so that the printhead die 251 are located at the bottom side of printhead 250, the droplets of ink being ejected downward onto the recording medium in print region 303 in the view of FIG. 5. Multi-chamber ink supply 262, in this example, contains five ink sources: cyan, magenta, yellow, photo black, and colorless protective fluid; while single-chamber ink supply 264 contains the ink source for text black.

Since the ink supplies 262 and 264 are located at a vertically higher position than the nozzles, in order to keep ink from drooling out of the nozzles, a source of back pressure is typically provided in the ink supplies 262 and 264. For example, a porous capillary medium (not shown), such as felt or foam, can be provided in each of the supplies. Typically, the back pressure is designed to be around −2 inches of water for a full ink supply and around −10 inches of water for a nearly empty ink supply. If the magnitude of the back pressure is less than around 2 inches of water, nozzle drooling can occur. If the magnitude of the back pressure exceeds around 10 inches of water, ink starvation can occur in the drop generator, due to too little ink being refilled into the chamber.

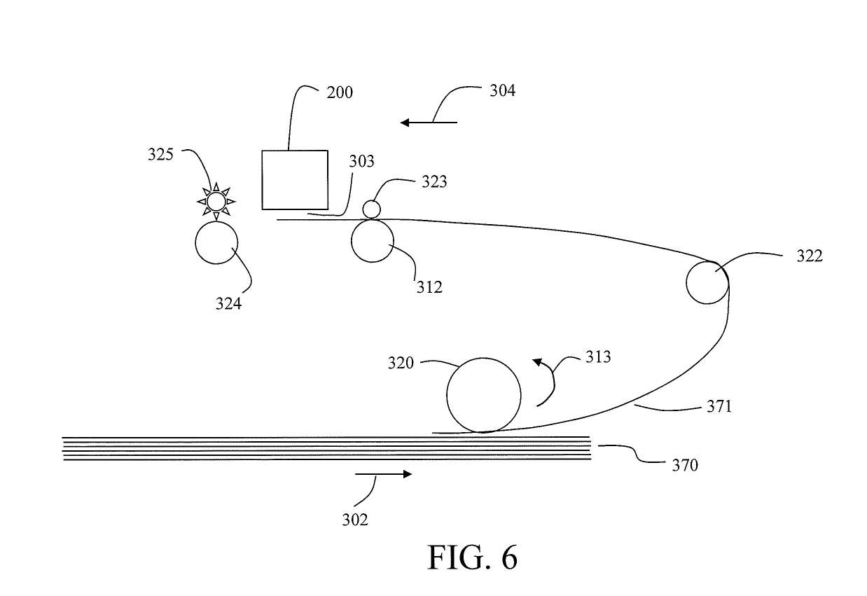

Paper or other recording medium (sometimes generically referred to as paper or media herein) is loaded along a paper load entry direction 302 toward the front of a printer chassis 308. A variety of rollers are used to advance the medium through the printer as shown schematically in the side view of FIG. 6. In this example, a pick-up roller 320 moves the top piece or sheet 371 of a stack 370 of paper or other recording medium in the direction of arrow, paper load entry direction 302. A turn roller 322 acts to move the paper around a C-shaped path (in cooperation with a curved rear wall surface) so that the paper continues to advance along media advance direction 304 from the rear 309 of the printer chassis 308 (with reference also to FIG. 5). The paper is then moved by a feed roller 312 and idler roller(s) 323 to advance along the Y axis across print region 303, and from there to a discharge roller 324 and star wheel(s) 325 so that printed paper exits along media advance direction 304. Feed roller 312 includes a feed roller shaft along its axis, and feed roller gear 311 is mounted on the feed roller shaft. Feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 5, but a hole 310 at the right side of the printer chassis 306 is where the motor gear (not shown) protrudes through in order to engage a feed roller gear 311, as well as the gear for the discharge roller (not shown). For normal paper pick-up and feeding, it is desired that all rollers rotate in forward rotation direction 313. Toward the left side of the printer chassis 307, in the example of FIG. 5, is a maintenance station 330 including a cap 332.

Toward the rear of the printer chassis 309, in this example, is located an electronics board 390, which includes cable connectors 392 for communicating via cables (not shown) to the printhead carriage 200 and from there to the printhead 250. Also on the electronics board 390 are typically mounted motor controllers for the carriage motor 380 and for the paper advance motor, a processor and/or other control electronics (shown schematically as controller 14 and image processing unit 15 in FIG. 3) for controlling the printing process, and an optional connector for a cable to a host computer.

Embodiments of the present invention include a drop ejector configuration where side walls of chamber are shaped to provide sufficient capillary pressure to cause the chamber to reprime in the event that it becomes emptied of liquid and there is no momentum of the liquid assisting chamber refill.

Without being bound by theory, an explanation of preferred configurations for drop ejectors will be provided in terms of capillary pressure as a function of the wall geometry and the contact angle between the ink and the walls. According to the Young-Laplace equation, the capillary pressure P_{c} is

P_{c}=(2γ/R)(cos(θ_{A}))=2γκ(cos(θ_{A})), (1)

where γ is the surface tension of the ink, R is the radius of curvature of the ink/air interface, κ is the curvature (i.e. the reciprocal of the radius R), and θ_{A} is the advancing contact angle between the ink and the drop ejector walls.

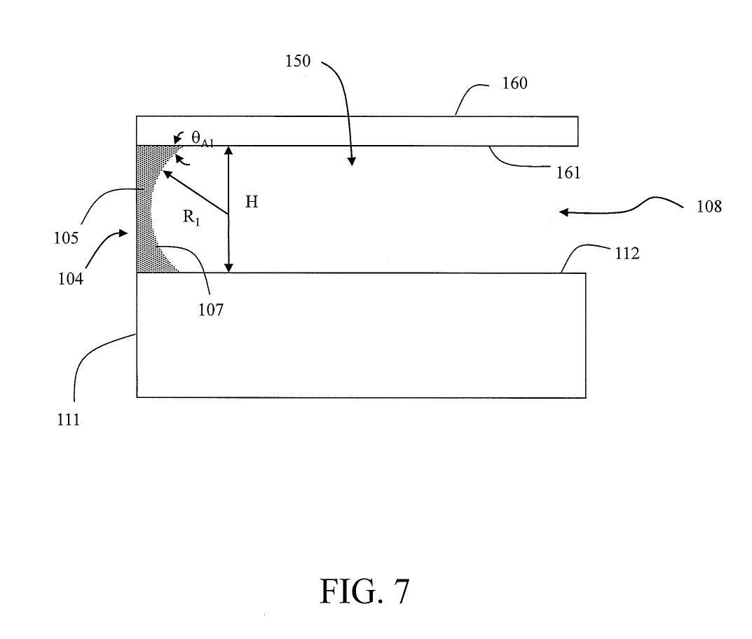

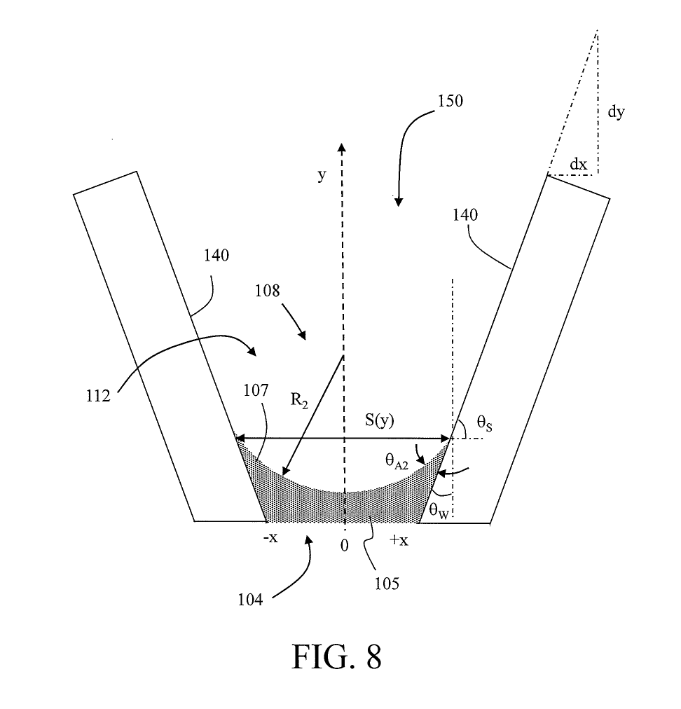

FIG. 7 shows a cross-sectional view of a portion of a chamber 150 of a drop ejector, where the section is perpendicular to the plane of the substrate 111. In this view the nozzle plate 160 and the substrate 111 are shown, but not the side walls of the chamber 150. The chamber height H is the distance between the upper surface 112 of substrate 111 and the lower surface 161 of the nozzle plate 160, and is substantially equal to the thickness of the side walls (not shown). Surface 112 defines an xy plane (see FIG. 8). Ink 105 enters the space between the substrate 111 and the nozzle plate 160 from the direction of an inlet 104. The radius of curvature R₁ of the interface 107 between the ink 105 and the air 108 is given by

R₁=H/(2 cos(θ_{A1})), (2)

where θ_{A1} is the advancing contact angle between the ink 105 and the nozzle plate 160. The corresponding curvature κ₁=1/R₁ is given by

κ₁=2 cos(θ_{A1})/H. (3)

FIG. 8 shows a cross-sectional view of a portion of the chamber 150 of FIG. 7, where the section is parallel to the xy plane of the substrate 111. Side walls 140 are formed on surface 112 of the substrate 111 and define the lateral boundaries of chamber 150. Side walls 140 are nonparallel and are angled toward each other near inlet 104. In this example, side walls 140 are mirror-symmetric about a y axis of the chamber 150. Ink 105 enters the chamber 150 from the direction of inlet 104. The spacing S(y) between the nonparallel side walls 140 is measured along the x direction. Since the side walls 140 are mirror-symmetric about the y axis, they extend from −x to +x, so that the spacing S(y)=2x. The width S(0)=2x₀ of inlet 104, where the inlet extends along the x axis at y=0. The advancing contact angle between the ink 105 and the side walls 140 is θ_{A2}. The angle between an ink-air interface 107 and a line parallel to the y axis is (θ_{A2}+θ_{W}), where θ_{W} is the angle between the angled side wall 140 and the y direction. The rate of change of y as a function of x for side wall 140 in this example is given by dy/dx=tan(π/2−θ_{W})=tan(θ_{S}), where θ_{S} is the complement of θ_{W}. The rate of change dy/dx is called the slope of the side wall 140. Side walls 140 are substantially perpendicular to surface 112 of substrate 111, and the word slope should not be confused with an angle of the side wall 140 with respect to the xy plane, but rather within the xy plane. The radius of curvature R₂ in this plane is given by

R₂=S(y)/2(cos(θ_{A2}+θ_{W}))=x/(cos(θ_{A2}+θ_{W})). (4)

The corresponding curvature is given by

κ₂=(cos(θ_{A2}+θ_{W}))/x. (5)

For calculating the capillary pressure (see equation 1), the principal curvatures κ₁ and κ₂ should be summed using expressions (3) and (5), i.e.

P_{c}=γ(κ₁+κ₂)=[(2 cos(θ_{A1})/H)+(cos(θ_{A2}+θ_{W}))/x)]. (6)

For the chamber to reprime readily, it is desirable for the capillary pressure P_{c} at the chamber inlet 104 to exceed the magnitude of the back pressure P_{B} provided by the ink tank. For cases where chamber height H is small enough, surface tension is great enough, and cos(θ_{A1}) is sufficiently close to 1 (i.e. the nozzle plate is sufficiently wetted by the ink), the κ₁ term alone can be sufficient for the capillary pressure at the chamber inlet 104 to exceed the back pressure. In such cases, the shape of the side walls 140 is not as important for refill. However, it has been found that for drop ejector chambers 150 designed with a large chamber height H to eject moderately large drops of ink that do not wet the chamber walls well, it can be useful to shape the side walls 140 so that the ink does not tend to get pinned at the inlet 104 of the chamber 150.

One way to describe the shape of side walls 140 that would provide sufficient capillary pressure to facilitate repriming of chamber 150 is in terms of dy/dx=tan(θ_{S}). (See FIG. 8.) Using trigonometric identities and rearrangement of equation (6) it can be shown that

θ_{S}=θ_{A2}+sin⁻¹[x(P_{c}/γ−2 cos(θ_{A1})/H]. (7)

In order to have side walls 140 provide sufficient capillary pressure to facilitate repriming of chamber 150, slope dy/dx should satisfy the inequality

dy/dx≧tan{θ_{A2}+sin⁻¹[x(P_{R}/γ−2 cos(θ_{A1})/H]}, (8)

where P_{R} is a predetermined refill pressure. For example, P_{R} can be greater than or equal to the upper limit of back pressure P_{B} provided by the ink supply during operation of the inkjet printer, i.e. P_{R} can be greater than or equal to 10 inches of water.

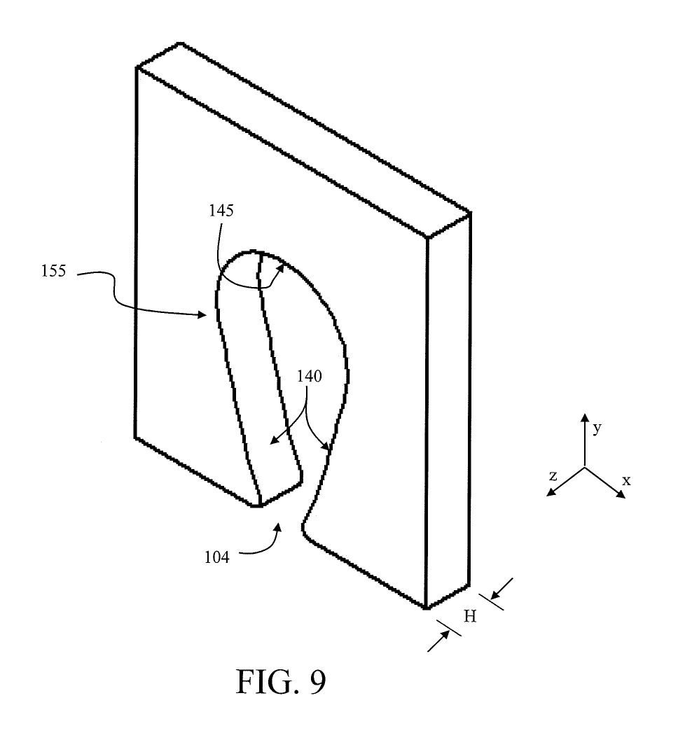

FIG. 9 shows a perspective view of the walls of a single-inlet chamber 155 of a drop ejector according to an embodiment of the invention, where at least near inlet 104, the side walls 140 satisfy inequality (8), assuming the surface tension γ=35 dyne/cm, the advancing contact angles θ_{A1} and θ_{A2} are both equal to 50 degrees, the refill pressure P_{R}=20 inches of water, and the chamber height H=12 microns. Single-inlet chamber 155 also includes a back wall 145 opposite inlet 104. Side walls 140 and back wall 145 are substantially perpendicular to the xy plane of the substrate 111. Although the substrate 111 and the nozzle plate 160 are not shown in FIG. 9, the thickness of the patterned layer forming side walls 140 and back wall 145 is substantially equal to the height H of the single-inlet chamber 155.

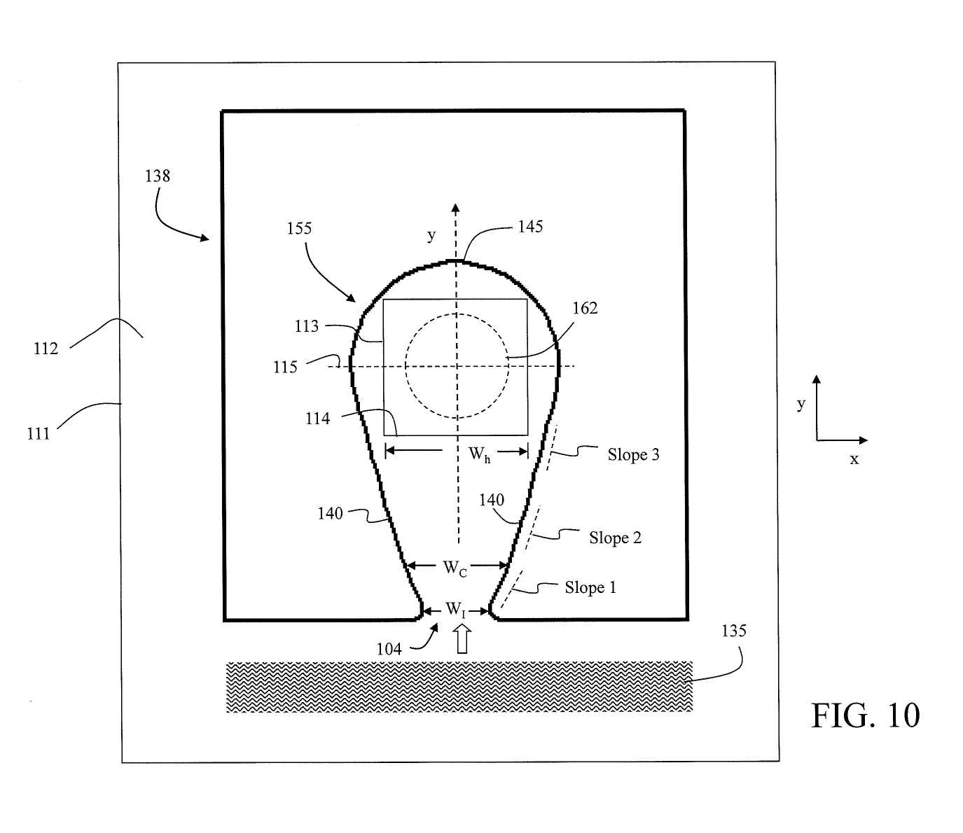

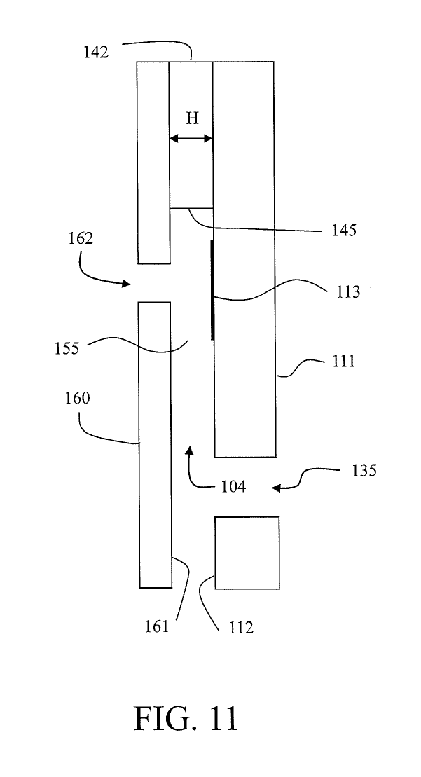

FIG. 10 is a top view of a drop ejector 138 including the single-inlet chamber 155 shown in FIG. 9, looking down through the nozzle plate 160 (see FIG. 11) toward the xy plane of the surface 112 of the substrate 111. A resistive heater 113 having a width Wₕ along an x direction is located near nozzle 162 and is partially enclosed by single-inlet chamber 155. The pair of non-parallel opposing side walls 140 define a variable width W_{C} of the single-inlet chamber along the x direction. Inlet 104 has an inlet width W_{I} (15 microns in this example) along the x direction where W_{I} is less than Wₕ. The variable width W_{C} of the chamber gradually increases between inlet 104 and an edge 114 of a resistive heater 113 that is nearest to the inlet 104. In the example shown in FIG. 10, the single-inlet chamber 155 includes a y axis, and the side walls 140 and the resistive heater 113 are mirror-symmetric about the y axis. Resistive heater 113 is displaced from inlet 104 along the y axis. The shape of the side walls 140 satisfies inequality (8) from inlet 104 to a midpoint 115 of resistive heater 113. By comparing Slope 1 of the side wall 140 near inlet 104 to Slope 3 of the side wall 140 nearer to an edge 114 of resistive heater 113 to Slope 2 at a point intermediate between these two regions, it can be seen that side wall 140 has a variable slope dy/dx that gradually increases between inlet 104 and edge 114 of resistive heater 113 that is nearest to the inlet 104. Unlike the prior art configuration discussed above relative to FIG. 2, single-inlet chamber 155 does not have distinct channel, neck and inlet regions having abruptly different slopes. Rather, single-inlet chamber 155 has an inlet 104 positioned near an ink feed 135, and side walls 140 whose slope gradually increases from the inlet 104 toward the resistive heater 113. The chamber wall from the midpoint 115 of resistive heater 113 to back wall 145 has the shape of a semicircle in this example. The portion of back wall 145 that is intersected by the y axis is perpendicular to the y axis. Unlike the prior art configuration discussed above relative to FIG. 2, single-inlet chamber 155 does not have corners where air bubbles and particulates can accumulate.

FIG. 11 is a cross-sectional view of a drop ejector 138 of FIG. 10 along the y axis. Substrate 111 includes the ink feed 135 that passes through the substrate 111. On the surface 112 of substrate 111, the resistive heater 113 is disposed to serve as a drop forming element. A patterned layer 142 is also formed on surface 112 and defines the walls of single-inlet chamber 155, including back wall 145 and side walls 140 (see FIG. 10). Formed over layer 142 is the nozzle plate 160 that is patterned to form a nozzle 162. The height H of single-inlet chamber 155 between surface 112 of substrate 111 and lower surface 161 of nozzle plate 160 is substantially equal to the thickness of layer 142.

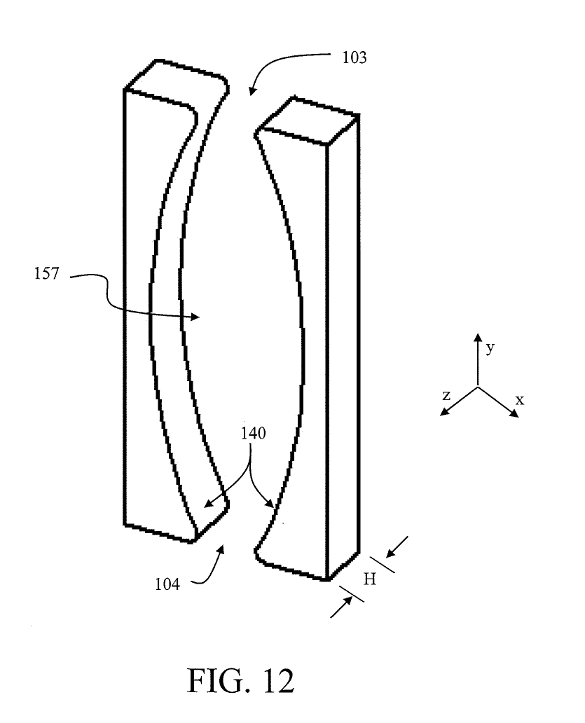

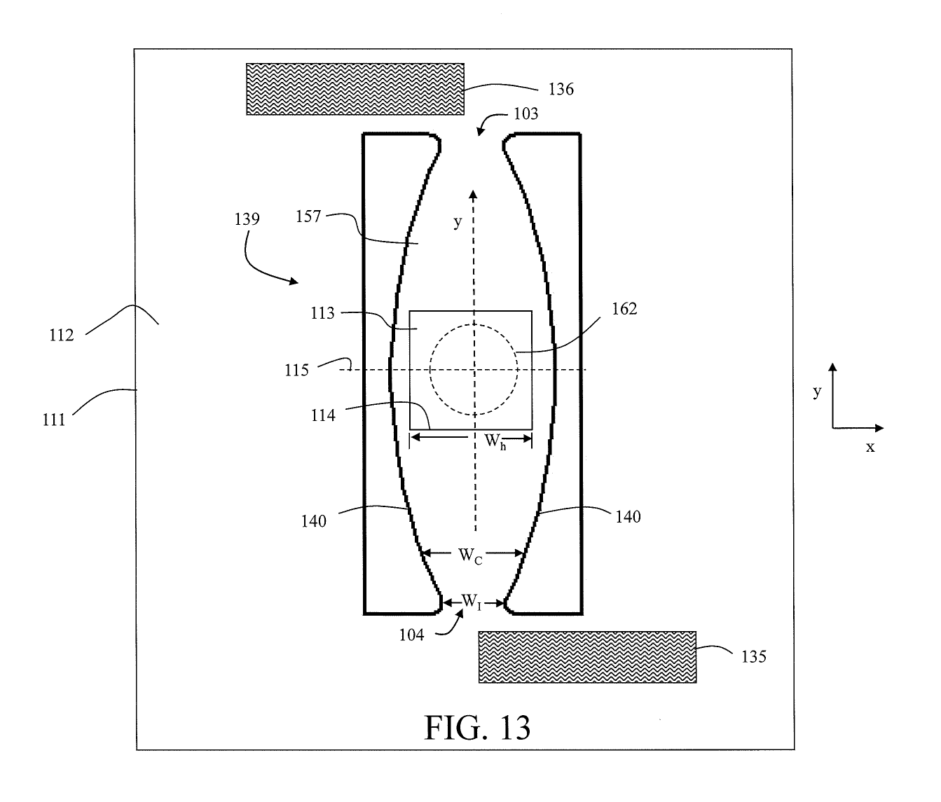

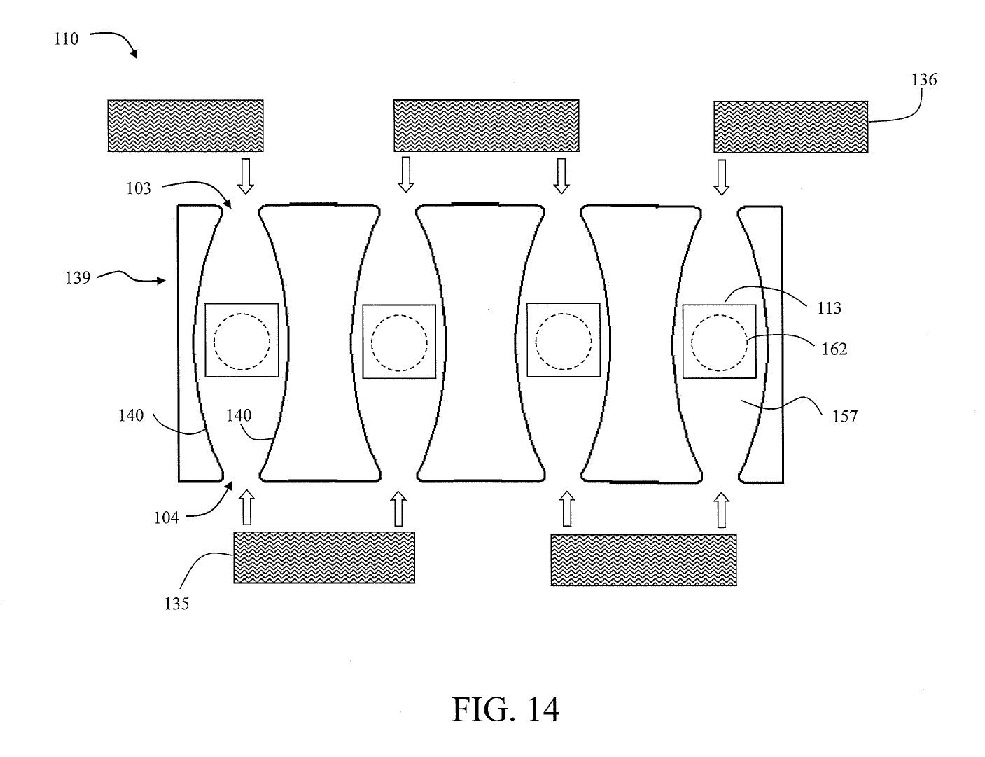

FIG. 12 shows a perspective view of a dual-inlet chamber 157 of a drop ejector according to another embodiment of the invention. A drop ejector 139, shown in the top view of FIG. 13, is a dual feed type structure, characterized by having ink feeds 135 and 136 (see FIG. 14) that provide ink to the dual-inlet chamber 157 from opposite sides of the chamber 157. Other dual feed configurations are described in commonly assigned U.S. Pat. No. 7,857,422, which is incorporated by reference herein in its entirety. Ink feeds 135 and 136 are staggered relative to one another and extend beyond drop ejectors 139 in order to provide ink to adjacent drop ejectors 139 (FIG. 14) through inlets 103 and 104 as indicated by the block arrows. By staggering the ink feeds 135 and 136 and providing spaces between ink feeds on a given side of the drop ejectors, electrical leads (not shown) for heater 113 can be routed to the heater, as is explained in more detail in U.S. Pat. No. 7,857,422. FIG. 14 shows a top view of a portion of the inkjet printhead die 110 having an array of four dual feed drop ejectors 139 of the type shown in FIGS. 12 and 13, together with corresponding ink feeds 135 and 136. Side walls 140 of adjacent chambers 157 are shared. For each of the drop ejectors 139 in the array, the first ink feed 135 is disposed near inlet 104, and the second ink feed 136 is disposed near a second inlet 103 of dual-inlet chamber 157. Ink feeds 135 and 136 are each shared between two adjacent drop generators 139. In that way the ink feeds can be spaced sufficiently to permit the provision of electrical leads (not shown) to heaters 113, while still providing ink flow to each dual-inlet chamber 157.

The dual-inlet chamber 157 shown in FIGS. 12 and 13 has many of the same characteristics as the single-feed chamber 155 shown in FIGS. 9 and 10. The primary difference is that rather than having a back wall, dual-inlet chamber 157 has a second inlet 103. At least near inlets 103 and 104, the slope dy/dx of side walls 140 satisfy inequality (8). In the example shown in FIGS. 12 and 13 it is assumed that the surface tension γ=35 dyne/cm, the advancing contact angles θ_{A1} and θ_{A2} are both equal to 50 degrees, the refill pressure P_{R}=20 inches of water, and the chamber height H=12 microns. Although the substrate and the nozzle plate are not shown in FIG. 12, the thickness of the patterned layer forming side walls 140 is substantially equal to the height H of the dual-inlet chamber 157.

FIG. 13 is a top view of the dual-feed drop ejector 139 including the dual-inlet chamber 157 shown in FIG. 12, looking down through the nozzle plate 160 toward the xy plane of the surface 112 of the substrate 111. The resistive heater 113 having a width Wₕ along an x direction is located near nozzle 162 and is partially enclosed by dual-inlet chamber 157. The pair of non-parallel opposing side walls 140 define a variable width W_{C} of the dual-inlet chamber along the x direction. Inlets 103 and 104 each have an inlet width W_{I} along the x direction where W_{I} is less than Wₕ. The variable width W_{C} of the chamber gradually increases between inlet 104 and the edge 114 of resistive heater 113 that is nearest to the inlet 104, and similarly near inlet 103. In the example shown in FIG. 13, the dual-inlet chamber 157 includes a y axis, and the side walls 140 and the resistive heater 113 are mirror-symmetric about the y axis. Resistive heater 113 is displaced from inlet 104 along the y axis. The shape of the side walls 140 satisfies inequality (8) from inlet 104 to the midpoint 115 of resistive heater 113. In addition, the shape of the side walls 140 satisfies inequality (8) from inlet 103 to the midpoint 115 of resistive heater 113. In other words, the pair of side walls 140 are substantially mirror-symmetric about line 115 perpendicular to the y axis of the chamber. Although the slopes of side walls 140 are not labeled in FIG. 13 as they are in FIG. 10, it can be seen that each side wall 140 has a variable slope dy/dx that gradually increases between inlet 104 and edge 114 of resistive heater 113 that is nearest to the inlet 104, and similarly near inlet 103. Unlike the prior art configuration discussed above relative to FIG. 2, dual-inlet chamber 157 does not have distinct channel, neck and inlet regions having abruptly different slopes. Rather, dual-inlet chamber 157 has inlets 103 and 104 positioned near ink feeds 135 and 136, and side walls 140 whose slope gradually increases from each inlet toward the resistive heater 113. Unlike the prior art configuration discussed above relative to FIG. 2, dual-inlet chamber 157 does not have corners where air bubbles and particulates can accumulate.

The invention has been described in detail with particular reference to certain preferred embodiments thereof, but it will be understood that variations and modifications can be effected within the spirit and scope of the invention. In particular, the invention has been described in the context of inkjet printing, but it can also be advantageously used for other types of drop ejectors.

### PARTS LIST

5 Inkjet printer system
10 Base plate (prior art)
11 Recording medium
12 Image data source
13 Heater
14 Controller
15 Image processing unit
16 Electrical pulse source
18 First fluid source
19 Second fluid source
20 Partition walls (prior art)
21 Chamber center
22 Chamber (prior art)
24 Ink path or channel (prior art)
25 Entry region (of channel)
26 Neck region (of channel)
27 Inlet (of chamber)
27a First edge (of inlet)
27b Second edge (of inlet)
28 Corner (of chamber)
29 Wall (of chamber)
30 Nozzle plate (prior art)
32 Nozzle (prior art)
35 Ink feed
100 Inkjet printhead
103 Inlet
104 Inlet
105 Ink
107 Interface

### PARTS LIST CONT'D

108 Air
110 Inkjet printhead die
111 Substrate
112 Surface (of substrate)
113 Heater
114 Edge (of heater)
115 Midpoint (of heater)
120 First nozzle array
121 Nozzle(s)
122 Ink delivery pathway (for first nozzle array)
130 Second nozzle array
131 Nozzle(s)
132 Ink delivery pathway (for second nozzle array)
135 Ink feed
136 Ink feed
138 Drop ejector
139 Dual-feed drop ejector
140 Side walls
142 Layer
145 Back wall
150 Chamber
155 Single-inlet chamber
157 Dual-inlet chamber
160 Nozzle plate
161 Lower surface (of nozzle plate)
162 Nozzle
181 Droplet(s) (ejected from first nozzle array)
182 Droplet(s) (ejected from second nozzle array)
200 Carriage

### PARTS LIST CONT'D

250 Printhead
251 Printhead die
253 Nozzle array
254 Nozzle array direction
256 Encapsulant
257 Flex circuit
258 Connector board
262 Multi-chamber ink supply
264 Single-chamber ink supply
300 Printer chassis
302 Paper load entry direction
303 Print region
304 Media advance direction
305 Carriage scan direction
306 Right side of printer chassis
307 Left side of printer chassis
308 Front of printer chassis
309 Rear of printer chassis
310 Hole (for paper advance motor drive gear)
311 Feed roller gear
312 Feed roller
313 Forward rotation direction (of feed roller)
320 Pick-up roller
322 Turn roller
323 Idler roller
324 Discharge roller
325 Star wheel(s)
330 Maintenance station
332 Cap

### PARTS LIST CONT'D

370 Stack of media
371 Top piece of medium
380 Carriage motor
382 Carriage guide rail
383 Encoder fence
384 Belt
390 Printer electronics board
392 Cable connectors

1. An inkjet printhead including a drop ejector, the drop ejector comprising:
a substrate having a surface disposed along an xy plane;
a nozzle plate including a nozzle;
a resistive heater disposed on the surface of the substrate proximate the nozzle, the resistive heater including a width along an x direction; and
a chamber at least partially enclosing the resistive heater, the chamber including:
a y axis;
a pair of nonparallel opposing walls defining a variable width of the chamber along the x direction; and
a chamber inlet having an inlet width along the x direction, the inlet width being less than the width of the resistive heater, wherein the variable width of the chamber gradually increases between the inlet of the chamber and an edge of the heater that is nearest to the inlet of the chamber.

2. The inkjet printhead of claim 1, wherein the pair of walls are substantially mirror-symmetric about the y axis of the chamber.

3. The inkjet printhead of claim 1 further comprising a back wall opposite the chamber inlet, wherein a portion of the back wall is perpendicular to the y axis.

4. The inkjet printhead of claim 1, the chamber inlet being a first chamber inlet, the drop ejector further comprising a second chamber inlet.

5. The inkjet printhead of claim 4, wherein the pair of walls are substantially mirror symmetric about a line perpendicular to the y axis of the chamber.

6. The inkjet printhead of claim 5, wherein the pair of walls are substantially mirror-symmetric about the y axis of the chamber.

7. The inkjet printhead of claim 5, wherein the resistive heater is substantially mirror-symmetric about the line perpendicular to the y axis of the chamber.

8. The inkjet printhead of claim 1, wherein the resistive heater is substantially mirror-symmetric about the y axis of the chamber.

9. The inkjet printhead of claim 1, a first wall of the pair of walls including a variable slope dy/dx, wherein the variable slope dy/dx of the first wall gradually increases between the inlet of the chamber and an edge of the heater that is nearest to the inlet of the chamber.

10. A drop ejector that is supplied with an liquid including a surface tension γ, the drop ejector comprising:
a substrate having a surface disposed along an xy plane;
a nozzle plate disposed at a distance H from the substrate, the nozzle plate being formed of a material having a contact angle θ_{A} with the liquid;
a drop forming element; and
a chamber at least partially enclosing the drop forming mechanism, the chamber including:
a y axis;
a pair of nonparallel opposing walls defining a variable width of the chamber along an x direction, the walls being formed of a material having a contact angle θ_{A} with the liquid; and
a chamber inlet having an inlet width along the x direction, a first wall of the pair of opposing walls including a slope dy/dx proximate the chamber inlet, wherein the slope dy/dx satisfies the inequality
dy/dx≧tan{θ_{A2}+sin⁻¹[x(P_{R}/γ−2 cos(θ_{A1})/H]}
where P_{R} is a predetermined refill pressure.

11. The drop ejector of claim 10, wherein P_{R} is equal to a back pressure of the liquid supplied to the drop ejector.

12. The drop ejector of claim 10, wherein the pair of walls are substantially mirror-symmetric about the y axis of the chamber.

13. The drop ejector of claim 10, wherein the predetermined refill pressure is greater than 10 inches of water.

14. The drop ejector of claim 10, wherein the drop forming mechanism is a resistive heater.

15. The drop ejector of claim 10, wherein the drop forming mechanism is displaced from the chamber inlet along the y axis.

16. The drop ejector of claim 10 further comprising a back wall opposite the chamber inlet, wherein a portion of the back wall is perpendicular to the y axis.

17. The drop ejector of claim 10, the chamber inlet being a first chamber inlet, the drop ejector further comprising a second chamber inlet.

18. The drop ejector of claim 17, wherein the pair of walls are substantially mirror symmetric about a line perpendicular to the y axis of the chamber.

19. The drop ejector of claim 18, wherein the pair of walls are substantially mirror-symmetric about the y axis of the chamber.

20. An inkjet printer comprising:
an ink supply including an ink having a surface tension γ, the ink in the ink supply having an upper limit back pressure P_{B} during operation of the printer; and
a printhead including a drop ejector, the drop ejector comprising:
a substrate having a surface disposed along an xy plane;
a nozzle plate disposed at a distance H from the substrate, the nozzle plate being formed of a material having a contact angle θ_{A} with the liquid;
a drop forming mechanism; and
a chamber at least partially enclosing the drop forming mechanism, the chamber including:
a y axis;
a pair of nonparallel opposing walls defining a variable width of the chamber along an x direction, the walls being formed of a material having a contact angle θ_{A} with the liquid; and
a chamber inlet having an inlet width along the x direction, a first wall of the pair of opposing walls including a slope dy/dx proximate the chamber inlet, wherein the slope dy/dx satisfies the inequality
dy/dx≧tan{θ_{A2}+sin⁻¹[x(P_{B}/γ−2 cos(θ_{A1})/H]}.
